(19) United States
(12) Patent Application Publication
(10) Pub. No.: US 2012/0168539 A1
(43) Pub. Date: Jul. 5, 2012

(54) DOUBLE FEED SPREADER HAVING TWO DISPENSING HOLES

(76) Inventor: Wan Soo Kim, Jeollabuk-Do (KR)

(21) Appl. No.: 13/394,832

(22) PCT Filed: Oct. 19, 2009
(86) PCT No.: PCT/KR2009/006015

§ 371 Date: Mar. 8, 2012

(30) Foreign Application Priority Data
Sep. 9, 2009 (KR) 10-2009-0084966

(51) Int. Cl. A01C 15/08

(52) U.S. Cl. 239/663; 239/682

(57) ABSTRACT

The present invention relates to a double feed spreader having two dispensing holes, constituted by forming two dispensing holes in a large-capacity feed spreader for dispensing granular feed and organic compost, and consequently by providing a dual shutter and a dual spreader fan to enable the quick and effective spreading of feed over a wide area. The double feed spreader of the present invention comprises: a rectangular large-capacity hopper fixed onto a frame and having a plurality of dispensing holes in the lower portion thereof; a dual shutter fixed onto the frame and mounted at the bottom of the dispensing holes so as to dispense organic compost and granular feed through a first and second outlet; a plurality of spreader fans fixed onto the frame so as to be rotatable by means of power received from another fanning implement, and installed at a bottom of the dual shutter; and a granular feed dispenser and an organic compost dispenser connected by a plurality of arms and operating levers to control the opening and closing of the first and second outlets of the dual shutter, wherein the dual shutter is configured to selectively dispense granular feed and organic compost through the first outlet and the second outlet. Accordingly, the above-described feed spreader of the present invention enables both the selective spreading of granular feed and organic compost over a wide area and the free transport of feed when using a large-capacity hopper, and prevents different feed from clumping together.

### FIELD OF THE INVENTION

The present invention relates to a double fertilizer spreader having dual dispensing holes, more particularly, a double fertilizer spreader having dual dispensing holes which can quickly and effectively perform the work of spreading of the fertilizer over a wide area by forming the dual dispensing holes in the fertilizer spreader of large capacity for discharging granular fertilizer and organic compost and accordingly providing the dual shutters and dual spreader fans.

### BACKGROUND OF THE INVENTION

In general, multi-purpose fertilizer spreader has an advantage that it can spread granular fertilizer of particle shape and also organic compost, thus is widely used in farms.

Then, the type of fertilizer as mentioned above is classified into granular fertilizer and organic compost, wherein the granular fertilizer is mainly chemical fertilizer such as calcium superphosphate, ammonium sulfate, potassium chloride etc. and the organic compost includes compost and barnyard manure, green manure, vegetable oil meals etc. and is normally called compost.

In order to enhance soil fertility by using various fertilizers as described above, fertilizer-spreading device is utilized, and multi-purpose fertilizer-spreading device has an advantage that it can spread both of the organic compost and granular fertilizer described above.

Since the organic compost as described above has no flowability and is highly viscous, dispensing holes should be relatively large for spreading of the organic compost, and in contrast, the granular fertilizer of particle shape should be spread through relatively small dispensing holes, hence the multi-purpose fertilizer-spreading device needs to be provided with two fertilizer dispensing holes.

In the case of providing separate dispensing holes for corresponding type of fertilizer, as described above, area of the holes is increased, and operation is not smoothly carried out, therefore dual shutter has been proposed which can discharge respective type of fertilizer through dual operation of the shutter while using one fertilizer dispensing hole.

The dual shutter as described above(disclosed in Korean Patent Application No. 10-2007-114861 filed by the applicant) has the following characteristics:

(1) shutter plate constituting the dual shutter can be made in a relatively small size;

(2) a structure can be provided wherein force is smoothly transmitted for moving the shutter plate leftward and rightward by applying the force from above;

(3) when a second outlet of the shutter is kept open, the second outlet can be automatically closed without separate operating of the second outlet at the time of closing the first outlet, therefore its operation is smoothly carried out.

Furthermore, a device for adjusting the spread of fertilizer can be provided wherein amount of discharge through the first and second outlets can be easily controlled in the multi-purpose fertilizer spreader by applying the dual shutter, which solves the above-mentioned problems, to the multi-purpose fertilizer spreader.

However, problems have appeared that the conventional fertilizer spreader as described above requires a hopper of large capacity in order to quickly spread the fertilizer over a wide area and efficient spread of fertilizer cannot be achieved when a single fertilizer dispensing hole is provided.

In addition, when dual dispensing holes are to be formed in the hopper, the conventional fertilizer spreader as described above requires a structure which enables the dual shutters for discharging the fertilizer to be operated simultaneously, and it is necessary to eliminate the phenomenon of fertilizer being lumped or caught within the hopper.

### SUMMARY OF THE INVENTION

Therefore, the present invention has been devised in order to solve the problems of the conventional fertilizer spreader as described above, and its object is to provide a double fertilizer spreader having dual dispensing holes which can selectively and widely spread the granular fertilizer and organic compost.

The above object is achieved by forming the dual dispensing holes in the hopper and providing the dual shutters having a first and second outlets, and dual spreader fans.

Another object is to provide a double fertilizer spreader having dual dispensing holes which use a plurality of dual shutters for discharging the granular fertilizer and organic compost and thus can discharge desired fertilizers simultaneously.

Such an object is achieved by using a plurality of dual shutters, connecting operating arms in such a manner that the dual shutters can be operated simultaneously, and controlling the opening and closing of the dual shutters.

Yet another object is to provide a double fertilizer spreader having dual dispensing holes which enables the fertilizer to be freely fed when a hopper of large capacity is used and can prevent a phenomenon of the fertilizer being lumped.

Such an object is achieved by installing stirring blades and a plurality of screw shafts within the hopper of large capacity to control flow direction of the fertilizer.

Yet another object is to provide a double fertilizer spreader having dual dispensing holes which discharge the fertilizer by using electrically-driven cylinder and at the same time also can manually discharge the fertilizer.

Such an object is achieved by connecting the electrically-driven cylinder to a manually-actuated operating lever via a coupling lever.

For achieving the above objects, a double fertilizer spreader having dual dispensing holes of the present invention is characterized in that the spreader comprises a rectangular hopper of large capacity fixed onto a frame and having a plurality of dispensing holes in the bottom portion thereof; dual shutters fixed onto the frame and mounted below the dispensing holes so as to discharge organic compost and granular fertilizer through a first and second outlet; a plurality of spreader fans fixed onto the frame and rotatable by means of power received from another farm machine, and installed below the dual shutters; and a granular fertilizer dispensing device and an organic compost dispensing device each connected by a plurality of arms and operating levers to control the opening and closing of the first and second outlets of the dual shutters.

Furthermore, the double fertilizer spreader of the present invention is characterized in that the dual shutter comprises a fixed body forming a certain frame; guide rods formed within the fixed body; rotational links rotatably coupled to both sides of the guide rods; upper and lower fixed rods coupled to the rotational links so as to be rotated; a shutter plate coupled with the guide rods through slide rods so as to move left/rightward and having a second outlet cut through the shutter plate; a first outlet formed by a space created through a left/rightward movement of the shutter plate; a fan rotatably coupled to a lower part of the shutter plate and having a second outlet cut through the fan, wherein a driving arm is fixed to one side of the fan; a connecting member arranged on one side of the shutter plate; and a driving device connected to the shutter plate through the connecting member to apply a driving power at the time of left/rightward movement of the shutter plate.

Furthermore, the double fertilizer spreader of the present invention is characterized in that in the rectangular hopper of large capacity, a plurality of stirring blades are formed on a upper shaft, and stirring blades and stirring screws are formed on an intermediate shaft in the middle and on the left/right sides thereof, respectively, and a plurality of stirring blades and stirring screws on the left/right sides are formed on a lower shaft, so that the fertilizer is fed to be collected around the dispensing holes.

Furthermore, the double fertilizer spreader of the present invention is characterized in that the granular fertilizer dispensing control device is connected to the driving arm, which adjusts angle of the second outlet formed in the shutter plate, via an operating lever and a connecting arm, and an electrically-driven cylinder is connected to the operating lever above the lever via a coupling lever, and in that the organic compost dispensing control device is connected to the driving device, which moves the shutter plate, via an operating lever, an operating arm and a connecting arm, and an electrically-driven cylinder is connected to the operating lever above the lever via a coupling lever.

The present invention as described above can use the dual shutter for discharging the organic compost and granular fertilizer to selectively discharge desired fertilizer, and there is an effect that, when a first outlet is used as an entrance for the organic compost and a second outlet is used as an entrance for the granular fertilizer, the highly viscous organic compost and granular fertilizer of particle shape can be spread, respectively.

Then, in the present invention as described above, even when a plurality of dual shutters are used, the dual shutters are operated simultaneously by using one operating arm, thus accurate control is possible, and in the situation where the electrically-driven cylinder cannot be operated, the operating arm can be manually actuated, thus it can be prevented that the fertilizer spreader cannot be operated due to occurrence of break down.

Furthermore, the present invention has an effect that, when the hopper of large capacity is used, by determining a feed direction of the fertilizer by means of the stirring blades and a plurality of screws, a problem can be avoided that feed is difficult because the organic compost is lumped or caught, and the present invention uses the hopper of large capacity and at the same time has a plurality of fertilizer dispensing holes, and can widely and quickly spread the fertilizer over a wide area by using the dual shutters and spreader fans, as can be seen from the following Table 1.

TABLE 1

| | Spread range(m) when | Spread range(m) when |
|---|---|---|
| | using one dispensing | using two dispensing |
| | hole and one dual | holes and two dual |
| Type | shutter | shutters |
| Granular fertilizer | 8~10 m | 15~20 m |
| Organic fertilizer | 3~7 m | 6~14 m |

### BRIEF DESCRIPTION OF THE DRAWINGS

FIG. 1 is a perspective view showing the front of the double fertilizer spreader having dual dispensing holes of the present invention.

FIG. 2 is an exploded perspective view showing construction of the dual shutter of the present invention.

FIG. 3 is a bottom view showing a state where the dual shutter of the present invention has been driven to the right.

FIG. 4 is a bottom view showing a driving state of the dual shutter of the present invention.

FIG. 5 is a perspective view showing the rear of the double fertilizer spreader having the dual dispensing holes of the present invention.

FIG. 6 is a perspective view showing essential parts of a device for adjusting the spread of fertilizer using the dual shutter of the present invention.

FIG. 7 is a partial sectional view showing components installed within a rectangular hopper of large capacity used in the present invention.

<list of reference numerals>

| | |
|---|---|
| 1: fixed body | 2, 2′: rotational link |
| 3: guide rod | 5: shutter plate |
| 6, 6′: second outlet | 7: fan |
| 8: driving arm | 9: connecting member |
| 10, 10′: dual shutter | 11, 11′: slide rod |
| 12: first outlet | 13, 14: fixed rod |
| 20: hopper | 25, 25′: dispensing hole |
| 21: articulation lever | 22: rotational lever |
| 27, 32: connecting arm | 35: slide dispensing plate |
| 29, 39: operating lever | 28, 35: operating arm |
| 50: granular fertilizer dispensing device | |
| 60: organic compost dispensing device | |
| 53, 63: electrically-driven cylinder | |
| 67, 72: screw | |

### DETAILED DESCRIPTION OF EXEMPLARY EMBODIMENTS

Hereinafter, examples of the present invention will be described in detail with reference to the attached drawings as follows.

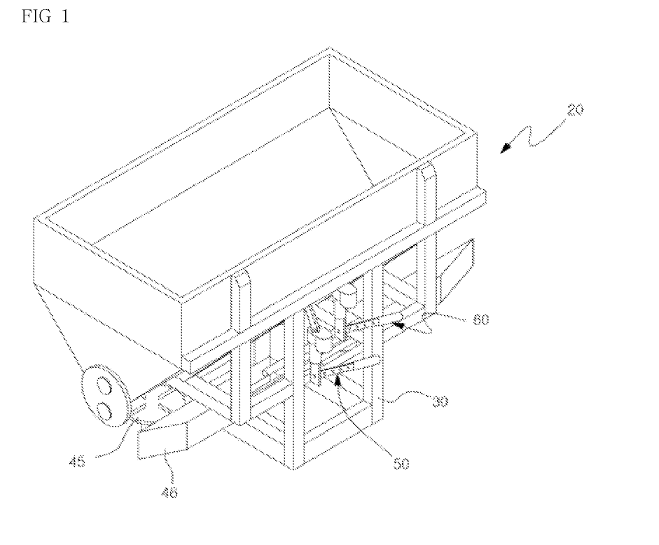

As shown in FIGS. 1 to 7, the spreader of the present invention comprises a rectangular hopper (20) of large capacity fixed onto a frame (30) and having a plurality of dispensing holes in the bottom portion thereof; dual shutters (10, 10′) fixed onto the frame and mounted below the dispensing holes so as to discharge organic compost and granular fertilizer through a first and second outlet; a plurality of spreader fans (45, 45′) fixed onto the frame so as to be rotatable by means of power received from another farm machine, and installed below the dual shutters (10, 10′); and a granular fertilizer dispensing device (50) and an organic compost dispensing device (60) each connected by a plurality of arms and operating levers to control the opening and closing of the first and second outlets of the dual shutters (10, 10′).

FIG. 1 is a perspective view showing the front of the double fertilizer spreader having two dispensing holes of the present invention.

The hopper (20) of the fertilizer spreader has the purpose of accommodating the compost or fertilizer and has a rectangular structure, wherein the hopper becomes narrower in its width toward its bottom portion and has two fertilizer dispensing holes in the bottom portion. The dual shutters as described later are installed below the dispensing holes and separate spreader fans are arranged below the shutters in order to spread the discharged fertilizer.

Since the hopper becomes narrower in its width toward its bottom, as described above, the fertilizer is guided downward due to its own weight, and stirrer or discharging screw(not shown) is installed within the hopper (20), and the hopper has large capacity.

The above-mentioned hopper (20) is fixed onto the frame (30), and the spreader fan (45) and scattering-preventing plate (46) are installed below the hopper, which will be clear from the following description.

Furthermore, dual shutter(not illustrated) is installed over the spreader fan (45), and granular fertilizer dispensing device (50) and organic compost dispensing device (60) are fixed onto the frame for opening and closing the dual shutter.

Furthermore, though not illustrated, the frame (30) fixed to the hopper (20) of large capacity is provided with a structure for connecting to the farm machine such as electrically-driven cylinder and tractor, and such a structure is identical to the conventional multi-purpose spreader, thus description thereof will be omitted.

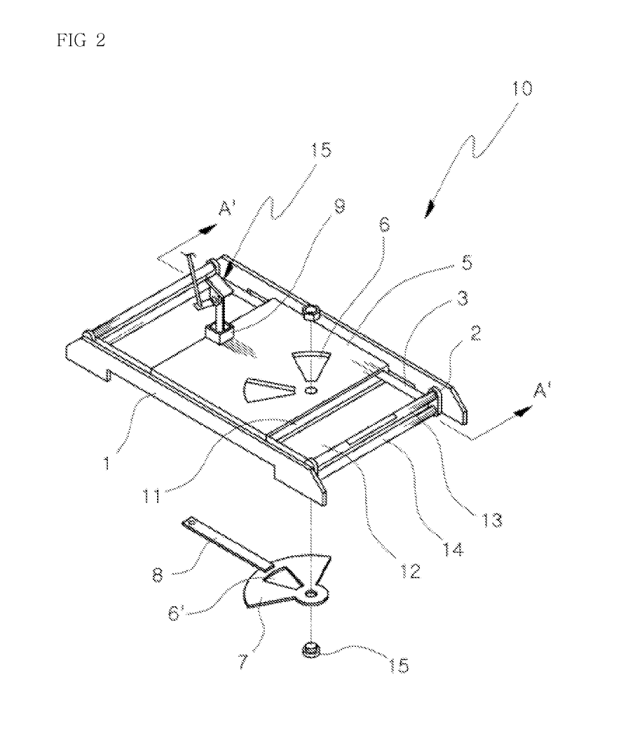

FIG. 2 is an exploded perspective view showing construction of the dual shutter of the present invention.

The dual shutter (10) comprises a fixed body (1), rotational links (2), guide rods (3) and a shutter plate (5), as illustrated.

In particular, the dual shutter has a dual structure where a second outlet (6) is formed in upper part of the shutter plate (5) and a first outlet (12) is formed by a space created through a leftward and rightward movement of the shutter plate (5).

The fixed body (1) provides a structure for fixing to the farm machine etc. described later.

The rotational links (2) are fixed to both sides of the fixed body (1), and a lower shaft of two shaft of the rotational links (2) is coupled with a fixed rod (14) through the fixed body (1) and a upper shaft is coupled through a fixed rod (13).

Furthermore, the fixed rod (14) of the lower shaft is fixed to the guide rod (3) through the rotational links (2) by means of welding, thus a rectangular frame is formed by the fixed rod (3) and guide rod (13), and the rotational links (2) are freely rotatable about a fixed shaft of the lower fixed rod (14).

The shutter plate (5) is seated through the guide rod (3) within the rectangular frame and a connecting member (9) is provided on one side of the shutter plate (5), which member enables the shutter plate (5) to be moved forward and backward by a driving power of a driving device (15), and the shutter plate has the second outlet (6) cut through the plate.

A shaft (not illustrated) for connection of the driving device (15) is arranged within the connecting member (9), however, of course, the driving device may be connected by means of various another connecting means such as a pin and the like.

The shutter plate (5) consisting of a rectangular body is formed with the arc-shaped second outlet (6), and below this outlet a fan (7) with a second outlet (6′) formed therein is rotatably coupled to the shutter plate through a fixing means.

A driving arm (8) is fixed to one side of the fan (7) by welding.

The dual shutter has two characteristics: first, when moving leftward and rightward, the shutter plate (5) receives the whole driving power of the driving device (15), so the shutter plate can be securely opened and closed even with less force.

Namely, a first entrance is positioned below a device, and the driving power of the driving device (15) is applied from above, therefore when the shutter plate (5) slides on the guide rod (3), rotational force included in left/rightward linear movement is also applied.

Thus, when the shutter plate (5) moves leftward and rightward, the shutter plate moves leftward and rightward while being rotated over a fixed angle by the rotational links (2), and the rotational angle at that time may be defined by the dimension of the rotational links.

As another characteristic, at the time of closing movement of the shutter plate (5), the second outlet (6) is always kept closed, thus even though the second outlet (6) is in an open state, separate closing movement is not necessary.

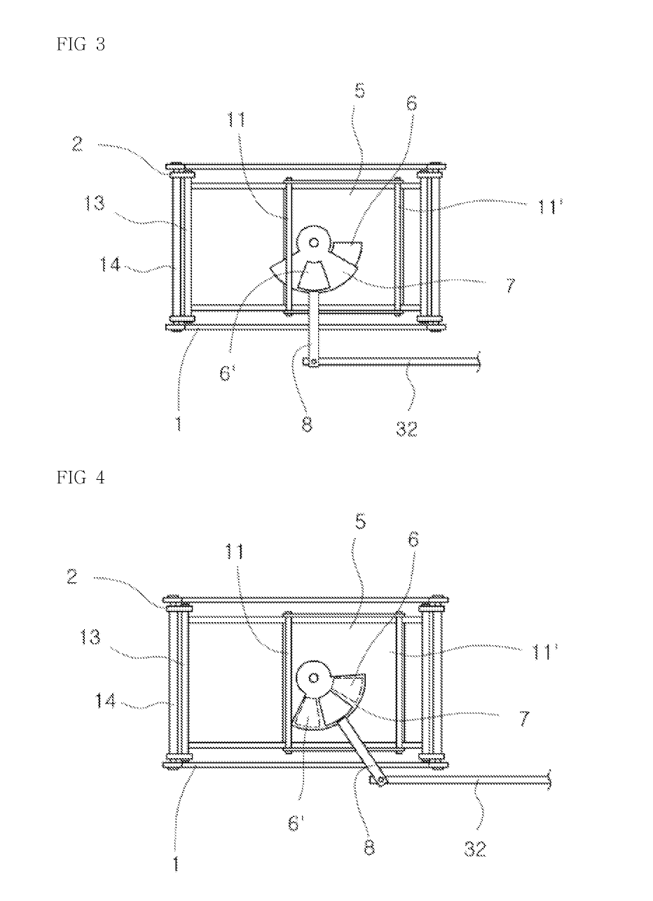

Namely, as shown in FIG. 3, when the shutter plate (5) moves rightward, a slide rod (11) fixed to lower part of the shutter plate (5) pushes the driving arm (8), thus the fan (7) is rotated about a central shaft to thereby close the second outlet (6), and in such a state of the second outlet being closed, the shutter plate (5) further moves rightward to close the first outlet (12).

FIG. 4 is a bottom view showing a driving state of the dual shutter of the present invention, and shows the state of the second outlet (6) being adjusted.

In the state of the first outlet (12) (refer to FIG. 1) being closed by the shutter plate (5), if the connecting arm (32) coupled to the driving arm (8) is moved leftward and rightward, the fan (7) coupled to the shutter plate (5) is rotated accordingly, whereby opening angle of the second outlets (6, 6′) is controlled, thus desired amount of discharge is achieved.

Therefore, there are effects that the dual shutter (10) of the present invention can control the degree of opening and closing of the first outlet (12) by moving the driving device connected to the shutter plate, thus can adjust the amount in which relatively viscous or large objects are discharged, and that by adjusting rotational angle of the fan (7) arranged on the shutter plate (5) of the dual shutter (10), small-sized objects can be discharged through the second outlet, thus outlets of two types can be controlled by using one shutter plate (5).

Furthermore, there is further effect that when moving leftward and rightward, the shutter plate (5) can be rotated over a fixed angle by the rotational links (2), thus can be easily opened and closed even with less force and at the same time is suitable for controlling the outlet arranged below a device that applies driving power from above.

The operating state as described above is represented in more detail in Korean Patent Application No. 10-2007-0114861 which the applicant has previously filed, titled “FERTILIZER SPRAYER CONTROL DEVICE CONTROLLING THE FERTILIZER SPRAYER AMOUNT OF THE FERTILIZER DISTRIBUTOR USING THE DOUBLE SHUTTER”.

FIG. 5 is a perspective view showing the rear of the double fertilizer spreader having the dual dispensing holes of the present invention.

As described above, two dispensing holes (25, 25′) are formed in the bottom portion of the rectangular hopper (20) of large capacity, and below the dispensing holes, the above-described dual shutters (10, 10′) are fixed onto the frame.

Furthermore, the spreader fans (45, 45′) are mounted on the frame below the dual shutters (10, 10′) with a fixed distance therefrom. Each of the two spreader fans (45, 45′) is connected with one gear shaft (41) via an internal gear, and this gear shaft (41) is connected to PTO connecting body (42), wherein the PTO connecting body (42) is coupled with PTO shaft of the farm machine(not shown) to receive power from the farm machine and then rotate the spreader fans (45, 45′) through gear shifting.

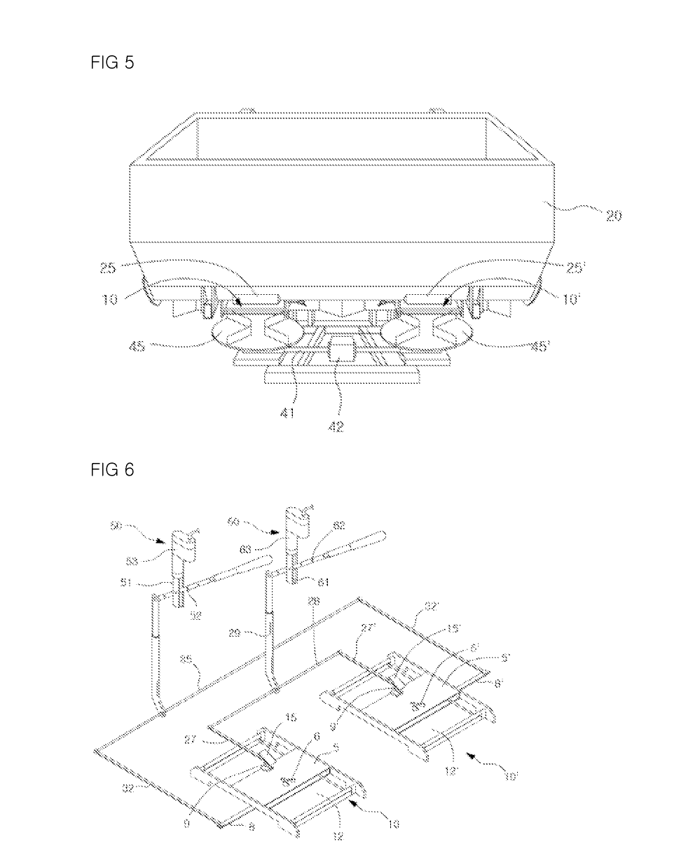

FIG. 6 is a perspective view showing essential parts of the device for adjusting the spread of fertilizer using the dual shutter of the present invention, wherein the organic compost dispensing device (60) is constructed which controls the driving device (15) connected through the connecting member (9) arranged on one side of the shutter plate (5) in order to control the first outlet (12), and the granular fertilizer dispensing device (50) is constructed which controls rotational angle of the driving arm (8) arranged on one side of the fan (7)(refer to FIG. 2) in order to control discharge amount of the second outlet (6).

Detailed description of the above is as follows. Fixed to the driving device (15) for moving the shutter plate (5) is a connecting arm (27), which is connected to an operating arm (28), and an operating lever (29) provided with a handle is connected to the operating arm (28) through a coupling lever (61).

Fixed to the coupling lever (61) is an electrically-driven cylinder (63), which is fixed at its one side to the frame, and coupling groove of the coupling lever (61) and coupling groove (62) of the operating lever (29) are coupled by bolt and nut.

Furthermore, an operating arm (35) is connected via the connecting arm (32) to the driving arm (8) which adjusts angle of the second outlet (6) (i.e., organic fertilizer outlet) formed in the shutter plate (5), and an operating lever (39) with a handle coupled thereto is connected to the operating arm (35) through a coupling lever (51).

Fixed to the coupling lever (51) is an electrically-driven cylinder (53) which is fixed at its one side to the frame, and coupling groove of the coupling lever (51) and coupling groove (52) of the operating lever (39) are coupled by bolt and nut.

Here, the electrically-driven cylinder (53, 63) may be replaced with hydraulic cylinder when required.

The above-described dual shutters (10, 10′) are dually constructed, but have a structure symmetric with each other, thus for the sake of convenience, the dual shutter (10) only is explained.

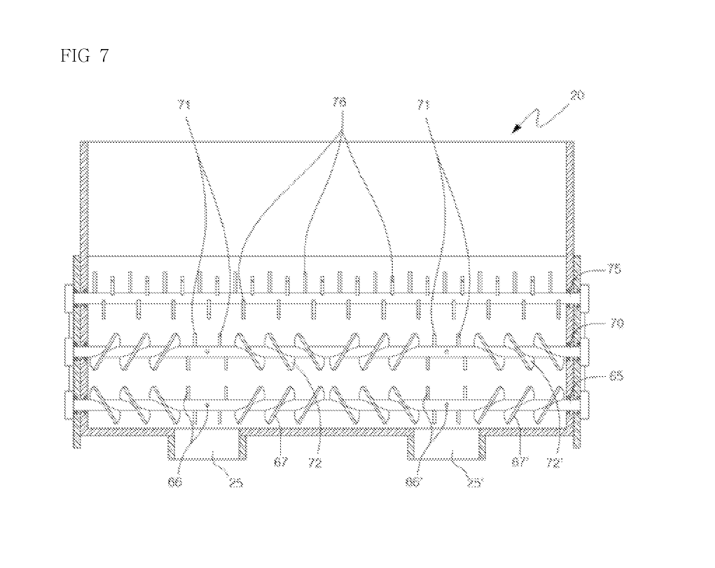

In the multi-purpose fertilizer spreader of the present invention constructed as above, the two dispensing holes (25, 25′) (refer to FIG. 7) are formed in the bottom portion of the hopper (20), and below the dispensing holes, the above-described dual shutters (10, 10′) are installed, and the spreader fans (45, 45′) are arranged below the dual shutters, wherein closed state of the shutter is achieved when the shutter plate (5) of the dual shutter (10) has fully moved to the right, as shown in FIGS. 3 and 4, and in this case, for discharging of organic compost through the second outlet (6), discharge angle of the second outlet (6) is set by rotating the driving arm (8), whereby desired amount of the fertilizer can be discharged.

At this time, if the handle is pulled, the lever (29) is moved, and accordingly the driving arm (8) is moved through the operating arm (28) connected to the lever (29), and desired amount of discharge is set. In the multi-purpose fertilizer spreader of the present invention, when the first outlet as outlet for the organic compost is closed, the granular organic material can be discharged through the second outlet as outlet for the granular fertilizer.

In such a state, when it is necessary to adjust the degree of opening of the first outlet for discharging the organic compost therethrough, the degree of opening of the first outlet can be controlled by the distance over which the shutter plate (5) is moved by applying force through the driving device (15) shown in FIG. 6, and desired amount of the fertilizer is discharged through the first outlet (12).

As described above, by forming the first outlet by the space created by movement of the shutter plate (5) and forming the second outlet in the shutter plate, desired organic compost and granular fertilizer can be discharged.

Furthermore, as described above, when the operating levers (39, 29) of the granular fertilizer dispensing device (50) and organic compost dispensing device (60) are rotated, the first and second outlets of the dual shutters (10, 10′) are opened or closed accordingly, thereby discharging the desired fertilizer. Usually, the operating levers (39, 29) are rotated by operating the electrically-driven cylinders (53, 63), but when electric power is not supplied due to occurrence of break down etc., the operating levers (39, 29) are manually rotated to discharge the desired fertilizer.

As described above, if the fertilizer is discharged through the dual shutters (10, 10′), the spreader fans (45, 45′) shown in FIG. 5 are rotated to thereby widely scatter the discharged fertilizer, wherein the rotation of the fans is achieved through rotation of PTO shaft of the farm machine (tractor etc.).

FIG. 7 is a partial sectional view showing components installed within the rectangular hopper (20) of large capacity used in the present invention, wherein a plurality of stirring blades (76) are formed on a upper shaft (75), and stirring blades (71) and counter-rotation screws (72) for prevention of clogging are formed on an intermediate shaft (70) in the middle and on the left/right sides thereof, respectively, and a plurality of stirring blades (66) and feeding screws (67) on the left/right sides are formed on a lower shaft (65).

The stirring blades of the upper shaft described above enable the organic compost to be stirred without being lumped and fertilizer within the hopper is scattered outward by the counter-rotation screws (72) for preventing of clogging on the intermediate shaft, and is collected around the dispensing holes (25, 25′) by means of the feeding screws (67) of the lower shaft (65) and then discharged through the holes, thus the fertilizer is smoothly discharged from the hopper of large capacity.

As can be seen from the above description, by forming the dual dispensing holes in the fertilizer spreader of large capacity for discharging the granular fertilizer and organic compost and providing the dual shutters and dual spreader fans accordingly, the present invention can quickly and effectively perform the work of spreading of the fertilizer over a wide area, thus can be usefully utilized in the field of agriculture or forestry where the a lot of fertilizer need to be spread.

What is claimed is:

1. A double fertilizer spreader having dual dispensing holes, comprising a rectangular hopper (20) of large capacity fixed onto a frame (30) and having a plurality of dispensing holes in the bottom portion thereof; dual shutters (10, 10′) fixed onto the frame and mounted below the dispensing holes so as to discharge organic compost and granular fertilizer through a first and second outlet; a plurality of spreader fans (45, 45′) fixed onto the frame and rotatable by means of power received from another farm machine, and installed below the dual shutters (10, 10′); and a granular fertilizer dispensing device (50) and an organic compost dispensing device (60) each connected by a plurality of arms and operating levers to control the opening and closing of the first and second outlets of the dual shutters (10, 10′).

2. The double fertilizer spreader having dual dispensing holes according to claim 1, wherein the dual shutter (10) comprises a fixed body (1) forming a certain frame; guide rods (3, 3′) formed within the fixed body; rotational links (2, 2′) rotatably coupled to both sides of the guide rods; upper and lower fixed rods (13, 14) coupled to the rotational links (2, 2′) so as to be rotated; a shutter plate (5) coupled with the guide rods (3, 3′) through slide rods (11, 11′) so as to move left/rightward and having a second outlet (6) cut through the shutter plate; a first outlet (12) formed by a space created through a left/rightward movement of the shutter plate (5); a fan (7) rotatably coupled to a lower part of the shutter plate (5) and having a second outlet (6′) cut through the fan, wherein a driving arm (8) is fixed to one side of the fan; a connecting member (9) arranged on one side of the shutter plate (5); and a driving device (15) connected to the shutter plate (5) through the connecting member (9) to apply a driving power at the time of left/rightward movement of the shutter plate (5).

3. The double fertilizer spreader having dual dispensing holes according to claim 1, wherein in the rectangular hopper (20) of large capacity, a plurality of stirring blades (76) are formed on a upper shaft (75), and stirring blades (71) and counter-rotation screws (72) for prevention of clogging are formed on an intermediate shaft (70) in the middle and on the left/right sides thereof, respectively, and a plurality of stirring blades (66) and feeding screws (67) on the left/right sides are formed on a lower shaft (65), so that the fertilizer is fed to be collected around the dispensing holes (25, 25′).

4. The double fertilizer spreader having dual dispensing holes according to claim 1, wherein the granular fertilizer dispensing control device (50) is connected to the driving arm (8), which adjusts angle of the second outlet (6) formed in the shutter plate (5), via an operating lever (29) and a connecting arm (32), and the organic compost dispensing control device (60) is connected to the driving device (15), which moves the shutter plate (5), via an operating lever (39), an operating arm (28) and a connecting arm (27), so that the fertilizer can be manually discharged by means of the operating levers (29, 39).

5. The double fertilizer spreader having dual dispensing holes according to claim 4, wherein an electrically-driven cylinder (53) is connected to the operating lever (29) of the granular fertilizer dispensing control device (50) above the lever via a coupling lever (51), and an electrically-driven cylinder (63) is connected to the operating lever (39) of the organic compost dispensing control device (60) above the lever via a coupling lever (61).
